(19) United States
(12) Patent Application Publication
(10) Pub. No.: US 2021/0327308 A1
(43) Pub. Date: Oct. 21, 2021

(54) ARTIFICIAL INTELLIGENCE ASSISTED SIGNAL MIMICRY

(71) Applicant: Parsons Corporation, Centreville, VA (US)

(72) Inventors: Joseph Payton, Fredericksburg, VA (US); Nicholas E. Ortyl, III, Bedford, MA (US); Joseph Keefe, Olney, MD (US); Samantha S. Palmer, Henrico, VA (US)

(73) Assignee: Parsons Corporation, Centreville, VA (US)

(21) Appl. No.: 17/231,293

(22) Filed: Apr. 15, 2021

Related U.S. Application Data
(60) Provisional application No. 63/011,797, filed on Apr. 17, 2020.

(51) Int. Cl. G09C 5/00; G06K 9/62; H04W 24/06; G06N 20/00

(52) U.S. Cl. CPC G09C 5/00; G06K 9/6257; G06N 20/00; G06K 9/6265; H04W 24/06

(57) ABSTRACT

The disclosed invention uses artificial intelligence (AI) algorithms for detecting and classifying radiofrequency (RF) transmissions to assemble a target signal library containing information about one or more target signals according to several criteria. A signal generator develops a mimic signal, designed to emulate a target signal based on information stored in the target signal library. In some embodiments, AI or machine learning (ML) algorithms further assist in refining the mimic signal to more effectively resemble the target signal. Such signal mimicry is done while maintaining small SWaP-C footprint for system component hardware.

### CROSS-REFERENCE TO RELATED APPLICATIONS

This application claims priority to U.S. Provisional Application No. 63/011,797, filed Apr. 17, 2020, and has specification that builds upon PCT/US20/46808, filed Aug. 18, 2020, PCT/US20/55370, filed Oct. 13, 2020, and U.S. Provisional Application No. 63/011,782, filed Apr. 17, 2020, the disclosures of which are hereby incorporated herein by reference in their entirety.

### BACKGROUND

### Field of the Invention

Embodiments of the present invention relate, in general, to signal transmission shaping, and more particularly to shaping a transmission to mimic other signal sources.

### Relevant Background

The number and sophistication of RF transmissions continue to evolve and increase. As a result, ensuring the security of RF transmissions remains an ongoing effort. As more and more transmitters, e.g., cell phones, internet of things (TOT) devices, etc., saturate the RF environment, and as the volume of sensitive information that is wirelessly transmitted grows, efforts to eavesdrop, monitor, appropriate, and impede such transmissions have also grown. Traditional security measures such as encryption have struggled to keep pace because methods to circumvent traditional security have also evolved.

Because the RF environment has grown increasingly crowded and complex, the benefits of achieving comprehensive awareness of that environment have increased. A snapshot of the RF environment, including detection and characterization of the signals in the environment, can allow the shaping of RF transmissions to blend into the RF environment, and further can allow the shaping of signals that mimic those of other transmitter types, including adversarial transmission systems. While the idea of using camouflage and mimicry is not new, their use to hide RF transmissions presents many challenges, given the sophistication of techniques to detect and monitor even the weakest of transmissions. A need therefore exists to accomplish comprehensive RF environment modeling to improve the security of RF transmissions by shaping them to mimic transmissions in the sampled RF environment. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the disclosure.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIG. 1 depicts a view of a general purpose computer for executing elements of the disclosed invention.

FIG. 2 depicts a flow diagram of artificial intelligence-assisted processes used in the disclosed invention.

FIG. 3 depicts a flow diagram describing at least a portion of an embodiment of the disclosed invention.

FIG. 4 depicts a flow diagram of artificial intelligence-assisted processes used in the disclosed invention.

FIG. 5 depicts a flow diagram of artificial intelligence-assisted processes used in the disclosed invention.

FIG. 6 depicts a flow diagram describing at least a portion of an embodiment of the disclosed invention.

FIG. 7 depicts a flow diagram describing at least a portion of an embodiment of the disclosed invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DEFINITIONS

“Artificial Intelligence” (AI) means a branch of computer science concerned with building smart machines capable of performing tasks that typically require human intelligence. AI is an interdisciplinary science with multiple approaches that allow machines to learn from experience, adjust to new inputs and perform human-like tasks. Using these technologies, computers can be trained to accomplish specific tasks by processing large amounts of data and recognizing patterns in the data.

“Intelligent Agent” or “Agent” means a program that can make decisions or perform a service based on its environment, experiences, and user input. It is an autonomous entity which acts, directing its activity towards achieving goals, upon an environment using observation through sensors and consequent actuators.

“Protocol” means an official set of procedures for what actions an Intelligent Agent is to take in a certain situation. A protocol generally describes a plan or the documents that spell out such a plan or an agreement of how to proceed.

“Size, Weight, Power, and Cost” or “SWaP-C” means the hardware footprint of a piece of equipment or system. Swap-C refers to the optimization of the four hardware factors as weighed against the capabilities of the equipment or system.

“RF Spectrum” or “Radio Spectrum” means the part of the electromagnetic spectrum with frequencies from 30 hertz to 300 GHz. Electromagnetic waves in this frequency range, called radio waves, are widely used in modern technology, particularly in telecommunications.

“RF Environment” means all of the transmissions in the RF spectrum propagating through a given geographic area.

“Bandwidth” means a range of frequencies within a given band, in particular those frequencies used for transmitting a signal.

“Software-defined radio” or “SDR” means a radio communication system implemented through software installed on a general or special purpose computer rather than through traditional hardware components, e.g., mixers, filters, amplifiers, modulators, signal detectors. A typical SDR may comprise a personal computer with a sound card linked to an RF front end. The computer's processor handles substantial portions of the signal processing, as opposed to the dedicated circuitry used in traditional radios. SDR systems are highly flexible as to radio protocols, and may accommodate a number of different and changing protocols in real time, e.g., cell phone services. SDRs can transmit using wideband, spread spectrum, and frequency hopping techniques to minimize interference within an RF environment. Further, a number of SDRs may be linked together into mesh networks reducing power requirements, size and interference caused by individual nodes in the network.

“Wide-Band Transcorder” or “WBT” means an SDR platform designed to record and replay any signal within the RF spectrum with a minimal SWaP-C footprint. The platform can be used for real-time or delayed analysis and manipulation of any signal captured in a particular RF environment. An exemplary device is capable of recording up to 100 MHz of RF spectrum at frequencies between 100 kHz and 18 GHz.

### DETAILED DESCRIPTION

The disclosed invention uses artificial intelligence algorithms for detecting and classifying radiofrequency transmissions to model and simulate an RF environment. AI/ML algorithms further assist in determining optimal modulation, bandwidth and center frequency placement of a transmit signal to mimic other transmission sources, which allows the transmit signal to evade detection, and therefore interception. Such signal shaping is done while maintaining small SWaP-C footprint for system component hardware.

The disclosed invention will now be described in detail with reference to several embodiments thereof as illustrated in the accompanying Figures. In the following description, specific details are set forth in order to provide a thorough understanding of embodiments of the disclosed invention. It will be apparent, however, to one skilled in the art that embodiments may be practiced without some or all of these specific details. In other instances, well known process steps and/or structures have not been described in detail in order to not unnecessarily obscure the invention. The features and advantages of embodiments may be better understood with reference to the drawings and discussions that follow.

It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the disclosed invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used to describe one element or feature's relationship to another element(s) or feature(s) as illustrated in the figures. Such spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used for AI-guided processes. Each block and combinations of block depicted in the flowchart illustrations, can be implemented by computer program instructions. These computer program instructions may be loaded onto a computer, a special purpose hardware-based computer system, or other programmable apparatus to produce a machine such that the executed instructions create means for implementing the functions specified in the flowchart block or blocks. These computer program instructions may also be stored in a computer-readable memory that can direct a computer or other programmable apparatus to function so that the instructions produce an article of manufacture that implements the function specified in the flowchart block or blocks. The computer program instructions may also be loaded onto a computer or other programmable apparatus to cause a series of operational steps to be performed so that the executed instructions provide steps for implementing the functions specified in the flowchart block or blocks.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

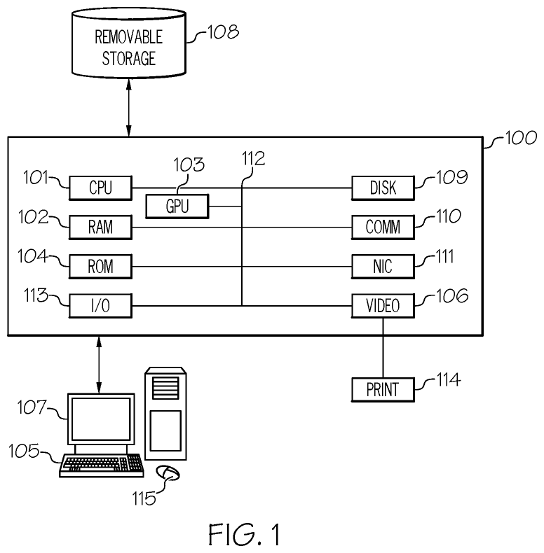

One having skill in the art will recognize that portions of the disclosed invention may be implemented on a specialized computer system, e.g., a wide band transcorder (WBT), or a general-purpose computer system, such as a personal computer (PC), a server, a laptop computer, a notebook computer, or a handheld or pocket computer. FIG. 1 is a general block diagram of a general purpose computer system in which software-implemented processes of the present invention may be embodied. As shown, the system 100 comprises one or more central processing unit(s) (CPU) or processor(s) 101 coupled to a random-access memory (RAM) 102, a graphics processing unit(s) (GPU) 103, a read-only memory (ROM) 104, a keyboard or user interface 105, a display or video adapter 106 connected to a display device 107 (e.g., screen, touchscreen, or monitor), a removable storage device 108 (e.g., floppy disk, CD-ROM, CD-R, CD-RW, DVD, etc.), a fixed storage device 109 (e.g., hard disk), a communication (COMM) port(s) or interface(s) 110, and a network interface card (NIC) or controller 111 (e.g., Ethernet). Although not shown separately, a real time system clock is included with the system 100, in a conventional manner.

The CPU 101 comprises a suitable processor for implementing the present invention. The CPU 101 communicates with other components of the system via a bi-directional system bus 112, and any necessary input/output (I/O) controller 113 circuitry and other “glue” logic. The bus, which includes address lines for addressing system memory, provides data transfer between and among the various components. RAM 102 serves as the working memory for the CPU 101. ROM 103 contains the basic I/O system code (BIOS), which is a set of low-level routines in ROM that application programs and the operating systems can use to interact with the hardware, including reading characters from the keyboard, outputting characters to printers 114, etc.

Mass storage devices 108, 109 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 1, fixed storage 109 stores a body of program and data for directing operation of the computer system, including an operating system, user application programs, driver and other support files, as well as other data files of all sorts. Typically, the fixed storage 109 serves as the main hard disk for the system.

In operation, program logic (including that which implements methodology of the present invention described below) is loaded from the removable storage 108 or fixed storage 109 into the main (RAM) memory 102, for execution by the CPU 101. During operation of the program logic, the system 100 accepts user input from a keyboard and pointing device 115, as well as speech-based input from a voice recognition system (not shown). The user interface 105 permits selection of application programs, entry of keyboard-based input or data, and selection and manipulation of individual data objects displayed on the screen or display device 107. Likewise, the pointing device 115, such as a mouse, track ball, pen device, or a digit in the case of a touch screen, permits selection and manipulation of objects on the display device. In this manner, these input devices support manual user input for any process running on the system.

The computer system 100 displays text and/or graphic images and other data on the display device 107. The video adapter 106, which is interposed between the display 107 and the system bus, drives the display device 107. The video adapter 106, which includes video memory accessible to the CPU 101, provides circuitry that converts pixel data stored in the video memory to a raster signal suitable for use by a display monitor. A hard copy of the displayed information, or other information within the system 100, may be obtained from the printer 114, or other output device.

The system itself communicates with other devices (e.g., other WBTs or computers) via the NIC 111 connected to a network (e.g., Ethernet network, Bluetooth wireless network, etc.). The system 100 may also communicate with local occasionally connected devices (e.g., serial cable-linked devices) via the COMM interface 110, which may include a RS-232 serial port, a Universal Serial Bus (USB) interface, or the like. Devices that will be commonly connected locally to the interface 110 include WBTs, laptop computers, handheld computers, digital cameras, etc.

The system may be implemented through various wireless networks and their associated communication devices. Such networks may include WBTs, mainframe computers, or servers, such as a gateway computer or application server which may have access to a database. A gateway computer serves as a point of entry into each network and may be coupled to another network by means of a communications link. The gateway may also be directly or indirectly coupled to one or more devices using a communications link, or may be coupled to a storage device such as a data repository or database.

### Artificial Intelligence Systems for Signal Detection and Classification

Certain functions of the disclosed invention are carried out by a system of intelligent agents that continually optimizes resources to progressively refine detection and characterization of radiofrequency signals in a given environment. The AI/ML systems used for signal detection and classification herein develop a data repository of an RF environment by extracting features from collected observations on the environment. Then the systems allow a suite of hierarchically organized intelligent agents to access the data repository to perform signal detection and classification. The signal classification system initially separates emitters from each other based on the characteristics of individually detected pulses, and then classifies the emitter groups using measured characteristics of each collection of pulses. These AI systems reduce the data burden and training time required to make fieldable, effective, and highly accurate signal detection capabilities, especially for traditionally difficult-to-capture protocols such as certain frequency agile communications. Using these systems, small SWaP-C footprint equipment can successfully detect and classify a new communications protocol in a matter of minutes.

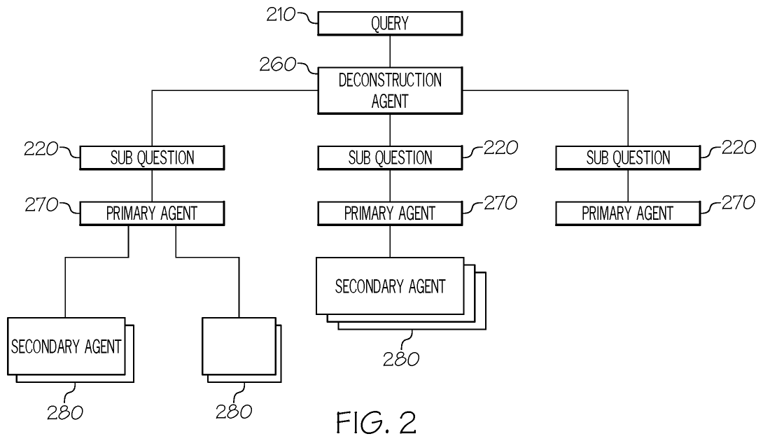

With reference to FIG. 2, for signal detection and classification, such systems use predetermined protocols to deconstruct or parse well-defined queries 210. A deconstruction agent 260 analyzes an inquiry and parses it into one more sub-questions 220, depending on the query's complexity. Then the deconstruction agent 260 passes each sub-question to a primary agent 270 based the nature of the sub-question. Examining data stored in a common database, the primary agent 270 assesses whether the current data is sufficient to resolve the sub-question or if additional data is required. If more information is needed, the primary agent seeks assistance from one or more secondary agents 280. Like the primary agent, the secondary agent receives the request and determines whether sufficient information is available to produce its response. Should the secondary agent also need additional information a tertiary agent can be sought, and so forth, until each sub-question is resolved. Upon resolution of each sub-question each primary agent passes its response back to the deconstruction agent, which combines the responses and resolves the inquiry in the form of an output.

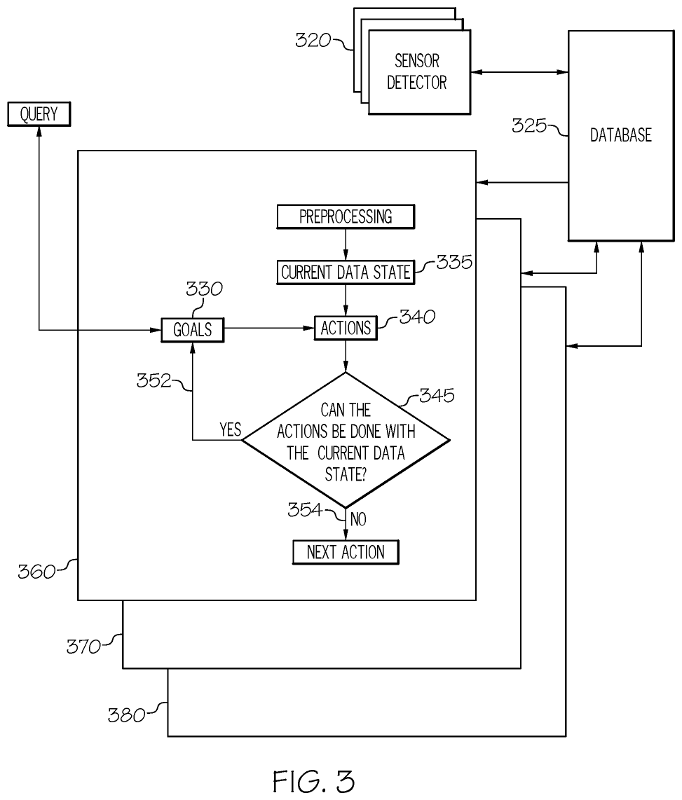

With reference to FIG. 3, an AI/ML system as used herein is depicted. The intelligent agents, i.e., deconstruction 360, primary 370, secondary, 380, tertiary (not shown), etc. are communicatively coupled to a database. Sensors 320 of various types capture and house data 325 relevant to a particular examination. The deconstruction agent 360 receives an inquiry 310 and parses it based on a predetermined protocol, which provides a framework to interpret the question and determine what information is necessary and what steps 330 (goals) are required to respond to the query. If the current state of the data 335 is sufficient 352 to support the required actions 340, the system generates a response and reports an output. However, if one or more actions/sub-questions cannot be completed 354 with current data, the deconstruction agent 360 seeks assistance of other agents 370, 380. In doing so the deconstruction agent assigns each sub-question or action to one or more primary agents 370. The primary agent 370 examines available data and determines whether the data is sufficient to resolve the sub-question. If so, the primary agent produces an output and returns it to the database. If the data is insufficient to resolve the sub-question, the primary agent 370 engages one or more secondary agents 380. Each of these secondary agents are tasked to develop or generate the data identified as lacking by the primary agent 370. Should the secondary agent 380 also determine that available data is insufficient for it to complete its task, it can task tertiary agents to generate missing data to allow the secondary agent to respond to the primary agent's request.

As agents produce additional data in response to a need identified by a superior agent, the output is placed in a common data repository 325. Each agent monitors the data repository for material sufficient for it to complete its assigned question. Upon an inferior agent adding new material to the database the superior agent recognizes the inclusion and works on its assigned task. Ultimately, the hierarchal structure provides sufficient information within the database for generation of a responsive output to the original query 310.

Specifically as applied to RF signal detection and classification, agents automatically detect signals, extract them, put them into a database and then accesses that database to provide relevant and actionable information. The agents rapidly assemble the pieces needed to provide relevant decision support information, e.g., is a signal detected, where and when was the signal detected, what class of signal is it, and in some cases, what vehicles are associated with that signal. Sensors, e.g., antennas, gather data that may otherwise resemble noise. Indeed, some frequency agile systems are designed to resemble noise by “hopping” among frequencies at a rate exceeding 80,000 hops per second. In such a system, spectrum accumulation and statistical fingerprint analysis models, are used to provide frequency estimates of RF signals. Such models, or predetermined protocols, establish what data is needed to determine if, for example, a UAV is present in the environment, and respond to such an inquiry.

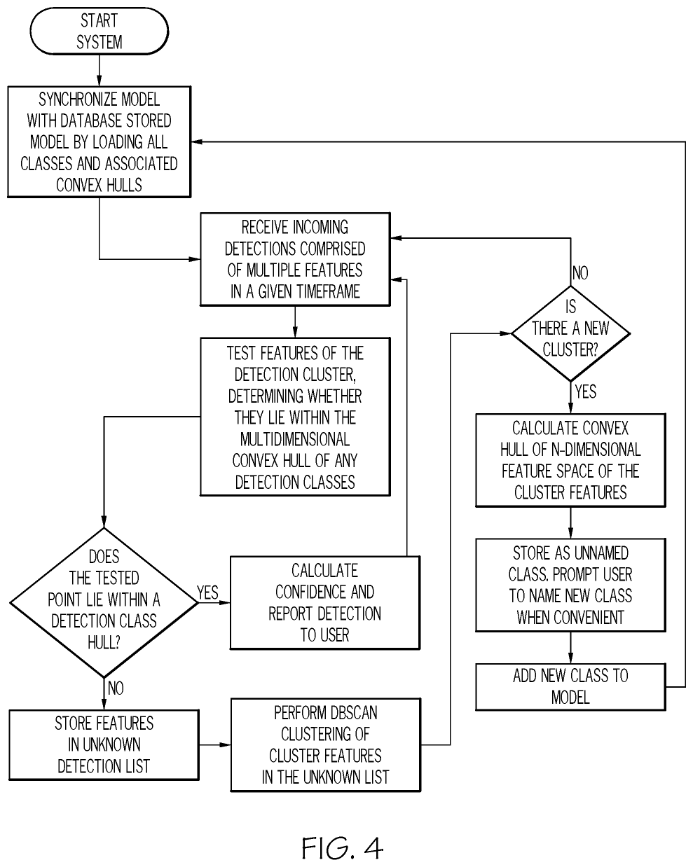

The AI/ML systems used herein perform RF signal detection and classification primarily through two algorithms: Density Based Spatial Clustering of Applications with Noise (“DBSCAN”), and Convex Hull. See FIG. 4 for a summary of the process as a block diagram. DBSCAN finds a finite number of spatially dense clusters in an n-dimensional feature space by constructing groups out of points that are in close proximity. DBSCAN is superior to other comparable clustering algorithms, e.g., k-means, because the number of groups do not need to be specified beforehand, and it can find non-linearly separable clusters. If DBSCAN cannot assign a point to a cluster, it initially labels the point as noise, i.e., unclassified.

The second such algorithm, known as Convex Hull, determines the minimum number of points in a cluster that can form a closed bounding region around all of the points in that cluster. A convex hull can be found algorithmically for a cluster of any number of dimensions. Convex hulls represent cluster boundaries, serving as a decision surface for establishing class membership. By calculating the convex hull boundary for a cluster, the system no longer requires all of the interior points associated with the cluster, which reduces the amount of memory required for storage and reduces the number of calculations needed to locate a new point inside or outside a cluster's boundary.

In operation, the AI/ML system receives data containing one or more features over a sliding window of time. This time window is large enough to allow a sufficient number of data elements or detections to allow the formation of meaningful clusters. The number of features passed into the system determines the number of dimensions in the feature space.

The system then tests each feature or data point against the convex hulls it has constructed from the data. If a point lies inside of a convex hull, the point is deemed a member of the class that the convex hull represents. The system can determine a confidence value for the point by examining the distance between the point and the convex hull surface, as well as the distance between the point and the center point of the cluster. Both distance measurements figure into the confidence value, since one convex hull can envelope another convex hull.

If a point lies outside of all convex hulls, it is stored in a sliding window of unclassified points. The unclassified points are then run though a DBSCAN clustering process to determine if there are any dense regions of points sufficient to create one or more new clusters. These clusters of unclassified points represent new classes (potential signals) that are added the model of the RF environment. Once a new cluster is established, i.e., shows persistence by including a minimum quantity of points during a given timespan, the system generates a convex hull out of the cluster's surface, and the new convex hull is assigned a name, either by the system, an auto generated unique designator, or by a human user.

Once a new class is established, the representative convex hull is added to the model of the RF environment, and is communicated to other intelligent agents through a Transfer Learning process. Transfer learning allows two or more agents to exchange classes and improved models among themselves. Transfer learning between models and agents is as simple as appending the new convex hull in one model to the set of convex hulls in another model.

While in some cases the system may require the generation of new information to answer an inquiry, in other cases the sensor-collected data is sufficient to answer the inquiry, but is not stored in a form usable by the system. Thus, when a query is issued, “Is a frequency agile UAV operating in a certain region of interest”, it must be parsed into resolvable and actionable sub-questions. The AI/ML system parses the question into actionable sub-questions using such protocols as “Within the detected data, are there groupings of time correlated signals”. To answer the query, an agent may need to examine pulse lengths, signal bandwidth, pulse power, etc., and analyze the data to identify a geospatial location of the signals. A response from each of a plurality of sub-questions leads to a resolution of the original query.

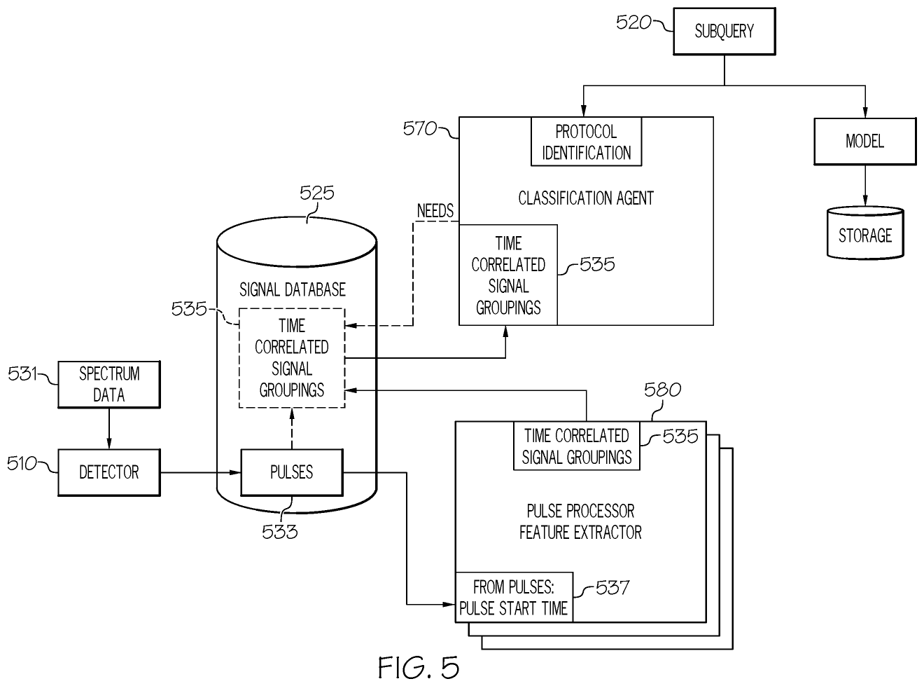

For example, with reference to FIG. 5, a subquery is assigned to a primary agent, such as a classification agent 570, to identify time-correlated grouped signals. The classification agent 570, recognizes that time-correlated grouped signals 535 are indicative of a frequency agile system. The classification agent therefore needs, and seeks to determine, whether the signal database 525 includes time-correlated grouped signals. Upon querying the database 525, the primary agent determines that the stored data are pulses 533 and are not time correlated. The primary agent 570 then issues a request to a secondary agent, a pulse processor feature extractor 580, to generate time correlated grouped signals 535 based information present in the database. The secondary agent 580 then seeks pulse start time kernel densities and signal time extents with which it can determine pulse start times 537. While pulse start time kernel densities can be derived from the signal time extents, the signal time extents must be derived from power spectral data, and Signal Frequency Extents which is an output of a complex Fast Fourier Transform. Working backward with a plurality of tertiary agents, a complex FFT modifies the original data 531 to generate power spectral data which in turn feeds the generation of, among other things, signal time extents. The signal time extents are the basis of another agent's generation of pulse start time kernel density data which, when combined with the signal time extents, forms pulse start time correlations 537.

Because of the tertiary agents' activities, the database now includes pulse start times 537 which the secondary agent 580 can use to generate time correlation-based signal groupings 535. These groupings are generated and placed in the database 525. After the inferior agents complete their tasks, the primary classification agent 570 now has the data (time correlation-based signal groups 535), required to return to the deconstruction agent a response to the subquery, “Have frequency agile signals been detected”. This response combined with other information can be combined to output a response to the initial query, “Is a frequency agile UAV operating in a certain region of interest?”

### Signal Mimicry

The AI/ML systems for detection and classification of radiofrequency signals in a given RF environment provide the foundation for certain embodiments of the disclosed system for shaping RF signals by adjusting modulation, bandwidth, center frequency placement, and the stable, pulsed or frequency agile profile of a transmit signal. Such signal shaping can inform the construction of signals that are shaped to resemble or mimic other transmission sources to evade detection in the RF environment. Signals are also optimized for transmission by low SWaP-C equipment. Low SWaP-C equipment may be characterized, for example, by a SDR that measures approximately 3 inches (″)×10″×15″ in outer dimensions, weighs around 15 pounds, and consumes less than 100 watts of power.

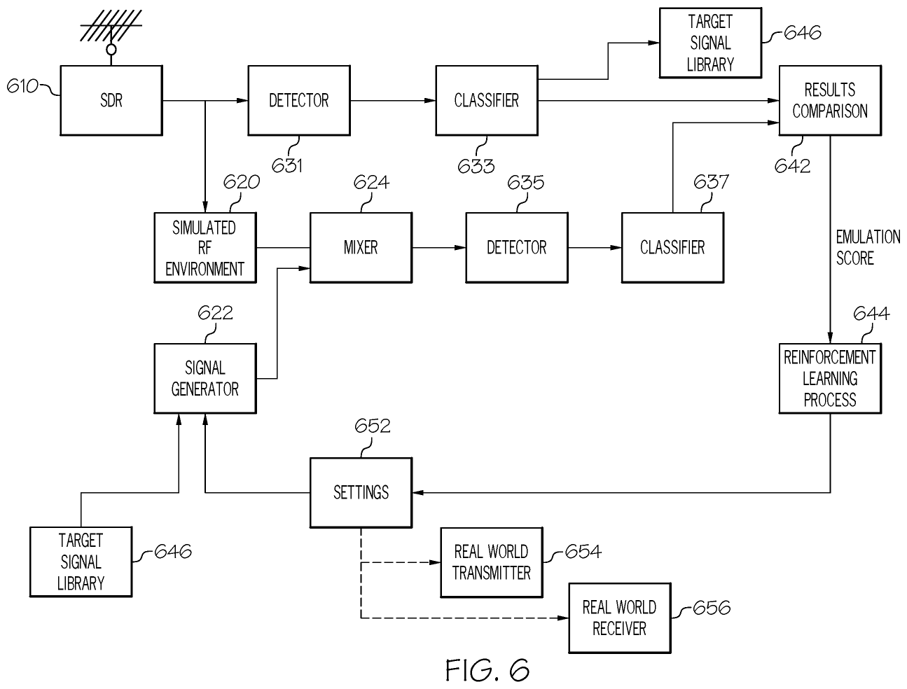

FIG. 6 depicts a block diagram of an embodiment of the disclosed mimetic signal system. One or more SDRs 610, such as a WBT platform, collects and records radiofrequency signals in a given RF environment. After sampling the RF environment, the system constructs and runs a simulation of the environment 620. The system also detects 631 and classifies 633 the external characteristics of other RF transmission sources, including, for example, cellphone, wife, near field communications, television, broadcast radio, satellite, telemetry, as well as signals transmitted by adversarial actors in the RF environment. Such classification allows detailed characterization of the detected transmissions according to several criteria, including transmission type, e.g., stable transmission, pulsed transmission, frequency agile transmission, and transmission source. Other criteria include center frequency range, center frequency placement, bandwidth, modulation, pulse length, pulse start time correlation, and pulse power. The characteristics of the detected/classified signals are organized into target signal profiles, and are stored in a target signal library 646. In some embodiments, the target signal library 646 is populated by profiles of known signal types based on previously sampled and classified transmissions. Newly sampled transmissions are compared to existing profiles in the library and are stored and labeled according to their similarity to the existing signal profiles. For example, a newly sampled transmission may be an example of an existing profile, it may be a variant of an existing profile, or it may be a new type of signal altogether.

Mimetic signals for eventual transmission are constructed and shaped 622 using various transmission parameters, which include the use of target signal profiles from the target signal library 646. For example, a cellular phone signal may be selected as a target signal to be emulated. The signal generator would produce a mimetic signal that resembles the targeted cell transmission, but that further includes a message intended for a receiver. Various levels of sophistication may be used to constrict the mimetic signal. For example, the mimetic signal may simply include generalized characteristics of the target signal, such as a particular communications standard, e.g., long-term evolution (LTE), or may be customized for a particular area, such as accounting for the local cellular communications standard that is in use and local frequency reuse patterns. In some embodiments, the mimetic signals may be constructed based on an active target signal library, which receives updated target signal profiles based on active sampling of the RF environment. In other embodiments, the mimetic signals are constructed based on a historical target signal library, which includes signal profiles that are constructed based on prior signal detection and collection, and which do not necessarily reflect characteristics of signals in the RF environment.

The target signal library 646 may also contain target signal profiles of adversarial communications signals. Similarly to other communications types, mimetic signals based on the target signal profiles may vary in detail and sophistication. For example, the military communications radios fielded by a particular national military may transmit according to a specialized communications protocol. A mimetic signal therefore might simply emulate general characteristics of the adversarial protocol. A more detailed mimetic signal might contain additional information about hardware artifacts, frequency patterns, transmission lengths, or other suitable factors that would assist the system in generating an accurate mimetic signal. The preliminary mimetic signal then is mixed 624 into the simulation.

The system runs AI/ML detection 635 and classification 637 processes on the mimetic signal mixed into the simulation. The detected/classified mimetic signal from the simulation is then compared 642 to detected/extracted signals sampled from the RF environment. The system compares the mimetic signal to a target signal or target signal type (e.g., cellular, wife, television, etc.) to determine the extent to which the mimetic signal resembles the target signal. In some embodiments, the system may also compare the mimetic signal as mixed into the simulation to the RF environment to determine how well the mimetic signal emulates the target signal within the context of its RF environment. As a result of such comparison(s), the mimetic signal is assigned an emulation score.

The emulation score is then fed into an AI/ML reinforcement learning process 644 which compares the emulation score of the mimetic signal to the emulation score(s) of any prior iterations. Depending on the user settings 652 specifying the types of refinements to make, and the emulation score sought, the mimetic signal is refined 622, mixed 624 back into the simulation, and the scoring process is repeated. After an optimal signal is constructed, e.g., a subsequent iteration (i+1) is no longer significantly different from the previous iteration (i) according to system settings, it may then be transmitted 654 into the RF environment where it can be received 656. In some embodiments, the RF environment is periodically re-sampled 610 and the simulation is updated to reflect changes in the RF environment over time.

In some embodiments, the system uses its AI/ML detection and classification capabilities to generate transmit signal parameters that will mimic other transmission sources in a similar manner to how “deepfakes” are generated for images. In the context of digital video footage, deepfake technology seeks to modify or generate footage of a person saying words they have not actually spoken such that the manipulated footage is indistinguishable from genuine unaltered footage. Deepfake technology uses two basic techniques to accomplish this goal. One is the use of an encoder and a decoder. The encoder is a universal program that translates an image of any person into a lower dimensional space which includes details about their basic facial and body posture characteristics. The decoder is a ML program that generates a model for a specific target by learning from available footage of the target speaking. The model is then used to generate new speaking sequences, and this is overlaid onto the basic facial and body features developed by the encoder. A second technique, known as a generative adversarial network (GAN), leverages another AI/ML process to improve the manipulated footage produced by the encoder/decoder process. Output from the encoder/decoder is passed to a discriminator program, which attempts to determine whether the output is real or fake. As the discriminator identifies weaknesses in the manipulated footage, this information is fed to the decoder. The decoder and discriminator continue to learn from the process, and evolve improving capabilities to generate and detect manipulated footage. As a result, convincing manipulated footage can be generated.

The disclosed signal shaping system functions similarly, but as applied to radiofrequency signals. The role of the encoder is fulfilled by the DPSCAN and convex hull algorithms, which encode detected artifacts from the RF environment. The decoder role is embodied by the signal generator function, which creates a mimetic signal which is overlaid onto the simulation. Then the system uses GAN architecture to improve the created signal. The system encodes/decodes the signal and simulation, and then compares it to target signals sampled from the RF environment, or to signal profiles stored in a library to determine the effectiveness of the mimicry. The system then iteratively improves the mimetic signal until the specified emulation and receivability scores are achieved. In a related embodiment, a receiver is informed of the signal generation process, allowing the receiver to easily locate and extract the transmitted message. In such embodiments, mimicry can be more sophisticated, since the receiver will have a narrower subset of spectrum and/or signal types to analyze when searching for the transmitted message.

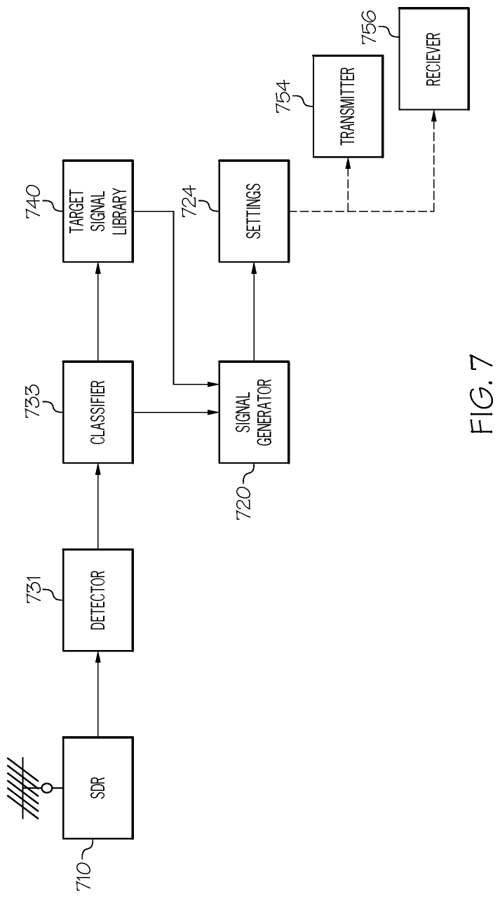

With reference to FIG. 7, in another embodiment of the disclosed system, the mimetic signal construction is simplified. One or more SDRs 710, such as a WBT platform, collects and records radiofrequency signals in a given RF environment. The system then runs AI/ML processes to detect 731 and classify 733 the external characteristics of RF transmission sources, including, for example, cellphone, wife, near field communications, television, broadcast radio, satellite, telemetry, as well as signals transmitted by adversarial actors in the RF environment. Such classification includes detailed characterization of the detected transmissions, including bandwidth, center frequency placement, pulse length, and pulse start time correlation. The characteristics of the detected/classified signals are organized into target signal profiles, and are stored in a target signal library 740.

The target signal profiles are also used to inform a signal generator 720, which uses the target signal profiles to construct mimetic signals for transmission. In some embodiments, the target signal library 740 also supplies profiles based on previously sampled and characterized signals. The mimetic signals are then adjusted by system settings, 724 which may be direct input or instructions from a user. Once adjusted, the mimetic signals are transmitted out via a transmitter 754, to be received by a receiver 756. Such a use of system settings 724 is distinct from the use of settings 624 as discussed for FIG. 6, which is part of an AI/ML refinement process to guide the mimetic signal into convergence with a set of criteria. According to such simplified embodiments, once the mimetic signal is constructed based on target signal profiles supplied by the target signal library 740 and adjusted according to the settings 724, it is transmitted. Such embodiments may accomplish signal mimicry with lower hardware, power, and computer processing requirements. However, without the use of AI/ML processes to refine the mimetic signal, such signals may be more easily distinguished from the target signal, which could increase the likelihood of interception.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words,” “materials,” etc. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for RF transmission shaping through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope of the invention.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

While there have been described above the principles of the present invention in conjunction with linked wide band transcorders, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

This has been a description of the disclosed invention along with a preferred method of practicing the invention, however the invention itself should only be defined by the appended claims.

What is claimed is:

1. A computer-implemented method for mimicking radiofrequency (RF) transmissions, the method comprising:
sampling RF signals from an RF environment;
using a machine learning (ML) detection algorithm to detect one or more RF signals sampled from the RF environment;
using an ML classification algorithm to characterize the one or more detected RF signals according to a plurality of signal criteria;
identifying a target signal from among the one or more characterized RF signals;
storing information about the target signal in a signal library, wherein the information includes a characterization of the target signal according to the plurality of signal criteria; and
developing a mimic signal using the stored information about the target signal.

2. The method of claim 1, wherein the plurality of signal criteria include: a center frequency, a bandwidth, a modulation, a transmission type, a pulse length, and a pulse start time correlation.

3. The method of claim 1, further comprising performing an iterative machine learning process, comprising:
assembling the sampled RF signals into a simulated RF environment;
mixing the mimic signal into the simulated RF environment to make a composite signal;
using a machine learning (ML) detection algorithm to detect the mimic signal in the composite signal;
using an ML classification algorithm to characterize the mimic signal according to a plurality of signal criteria;
comparing the mimic signal to the target signal to develop an emulation score;
adjusting the mimic signal based on the emulation score to develop a refined mimic signal;
performing the iterative machine learning process on the refined mimic signal until a final mimic signal is developed; and
transmitting the final mimic signal.

4. The method of claim 3, wherein the emulation score is a measure of how well the mimic signal matches the target signal according to one or more of the plurality of signal criteria.

5. The method of claim 1, wherein the RF signals are sampled using one or more software-defined radios.

6. The method of claim 3, further comprising receiving the final mimic signal with a receiver, wherein the receiver receives information about the final mimic signal.

7. A system for mimicking radiofrequency (RF) transmissions, the system comprising:
a receiver for sampling RF signals in an RF environment;
a first detector comprising a machine learning (ML) detection algorithm to detect one or more sampled RF signals sampled from the RF environment;
a first classifier comprising a ML classification algorithm to characterize the one or more sampled RF signals according to a plurality of signal criteria;
a target signal library for storing information about one or more characterized RF signals; and
a signal generator designed to develop a mimic signal based at least in part on information about a target signal stored in the target signal library.

8. The system of claim 7, wherein the plurality of signal criteria include: a center frequency, a bandwidth, a modulation, a transmission type, a pulse length, and a pulse start time correlation.

9. The system of claim 7, wherein the RF signals are sampled using one or more software-defined radios.

10. The system of claim 7, further comprising a transmitter and a second receiver, wherein the receiver receives information about the final mimic signal.

11. The system of claim 7, further comprising:
a simulator for developing a simulated RF environment comprised of the sampled RF signals;
a mixer designed to mix the mimic signal into the simulated RF environment to make a composite signal;
a second detector comprising a machine learning (ML) detection algorithm to detect one or more composite RF signals from the composite signal;
a second classifier comprising a ML classification algorithm to characterize the one or more composite RF signals according to the plurality of signal criteria;
a first comparator for comparing the one or more characterized composite RF signals to the one or more characterized sampled RF signals to develop an emulation score; and
a second comparator for comparing the emulation score to one or more transmission criteria.

12. The system of claim 11, wherein the emulation score is a measure of how well the mimic signal matches the target signal according to one or more of the plurality of signal criteria.
